(19) United States
(12) Patent Application Publication
(10) Pub. No.: US 2009/0168183 A1
(43) Pub. Date: Jul. 2, 2009

(54) OPTICAL MEMBER AND DISPLAY HAVING THE SAME

(76) Inventors: Seung-Mo KIM, Chunan-si (KR); Kim Joong-Hyun, Suwon-si (KR); Choi Jin-Sung, Chunan-si (KR); Kim Dong-Hoon, Suwon-si (KR)

Correspondence Address: F. CHAU & ASSOCIATES, LLC, 130 WOODBURY ROAD, WOODBURY, NY, 11797, US

(21) Appl. No.: 12/330,665

(22) Filed: Dec. 9, 2008

(30) Foreign Application Priority Data
Dec. 31, 2007 (KR) 10-2007-0141694

(51) Int. Cl. G02B 5/02; G02B 1/00

(52) U.S. Cl. 359/599; 428/411.1

(57) ABSTRACT

The present invention relates to an optical member for controlling light refraction and a display. An optical member of the present invention includes a base material and a foaming portion having a large number of foam elements. According to the present invention, a reflection or diffusion sheet can be manufactured by controlling the size of foam elements in the optical member. In addition, there is provided an optical member, which is formed of a foaming resin, which has no light diffusing agent in a base material layer and does not require a conventional stretching process, thereby securing light scattering power.

### CROSS-REFERENCE TO RELATED APPLICATION

This application claims priority to Korean Patent application No. 10-2007-0141694, filed on Dec. 31, 2007, the contents of which are herein incorporated by reference in their entirety.

### BACKGROUND OF THE INVENTION

1. Technical Field

The present disclosure relates to an optical member and a display having the same, and more particularly, to an optical member for controlling light refraction and a display having the same.

2. Discussion of the Related Art

Since a liquid crystal display (LCD) panel is not self-luminescent, a backlight assembly is attached as a light source behind the LCD panel, thereby implementing images.

The backlight assembly includes an edge type and a direct type classified according to the position of a light source with respect to a display surface. In the edge type backlight assembly, a lamp is positioned at a side of the display surface. Thus, a light guide plate for converting linear light from the lamp into surface light projected toward the display surface is used. In the direct type backlight assembly, a lamp is positioned directly behind the display surface, so that no light guide plate is used. The direct type backlight assembly has better light efficiency and a simpler structure than the edge type backlight assembly, so that the direct type backlight assembly is used for large-sized LCDs.

The direct type backlight assembly includes a plurality of lamps mounted under the display surface, a reflective plate for reflecting light emitted from the lamps to the display surface to prevent loss of light, and a diffusion plate and a diffusion sheet for diffusing light over the lamps to uniformly emit light.

Since the direct type backlight assembly has lamps arranged on a plane, the shapes of the lamps (e.g., bright lines) appear on an LCD panel. Thus, a sufficient gap between the lamps and the LCD panel should be maintained. However, in the direct type backlight assembly, since a plurality of lamps are positioned behind the display surface, the rear surface of the diffusion plate positioned perpendicular to the lamps is different in light intensity from the rear surface of the diffusion plate positioned between the lamps, which results in luminance nonuniformity.

To reduce the nonuniformity of luminance, a diffusion sheet is manufactured by a method in which a light diffusing agent is added into the diffusion sheet and the diffusion sheet is stretched in lateral and longitudinal directions by three-times or four-times. However, the stretching process is a complicated process lowering a production yield.

### SUMMARY OF THE INVENTION

According to exemplary embodiments, light scattering power of an optical member is increased to prevent the formation of bright lines and to enhance luminance and uniformity of light from a light source, and a gap between lamps and an LCD panel is shortened.

According to an aspect of the present invention, there is provided an optical member which includes a base material layer; and a foaming portion formed in the base material layer, the foaming portion having a large number of foam elements.

Here, the base material layer may include polyethylene terephthalate (PET) or polypropylene (PP). The foam elements may have an average size of 10 to 100 μm or an average size of 10 μm or less.

In addition, the optical member may further include a plurality of beads arranged on at least one surface of the base material layer. The beads may have an average size of 10 to 20 μm. The plurality of beads may include two or more types of beads with different indices of refraction. The plurality of beads may be formed on both the surfaces of the base material layer, and the number of beads formed on any one surface of the base material layer may be larger than that of beads formed on the other surface thereof.

A plurality of beads may be formed on one surface of the base material layer, and a shielding pattern may be formed on the other surface thereof.

According to another aspect of the present invention, there is provided a display which includes an optical member, which includes: a base material layer; and one or more shielding patterns formed on at least one surface of the base material layer.

Here, the shielding patterns are arranged in a line shape by grouping a series of the shielding patterns. The shielding pattern may have a width of 0.1 to 10 mm.

According to a further aspect of the present invention, there is provided a display, which includes: a backlight assembly having a light source unit and an optical member containing a foaming portion formed in a base material layer, the light source unit emitting light to be incident on the optical member, the foaming portion having a large number of foam elements; and a display panel disposed at a light exiting side of the backlight assembly to display an image.

Here, the foam elements may have an average size of 10 to 100 μm or an average size of 10 μm or less. A shielding pattern portions formed by grouping a series of shielding patterns may be formed on at least one surface of the base material layer in correspondence to the light source unit.

The optical member may be at least any one of a diffusion sheet, a reflection sheet and a diffusion plate.

### BRIEF DESCRIPTION OF THE DRAWINGS

Exemplary embodiments of the present invention can be understood in more detail from the following description taken in conjunction with the accompanying drawings, in which:

FIG. 1A is a sectional view of an optical member according to an exemplary embodiment of the present invention;

FIG. 1B is a sectional view of an optical member according to an exemplary embodiment of the present invention;

FIG. 1C is a scanning electron microscope (SEM) photograph of a sectional view of an optical member according to an exemplary embodiment of the present invention;

FIG. 1D is a photograph schematically showing a path of light passing through an optical member according to an exemplary embodiment of the present invention;

FIG. 2 is a sectional view of an optical member according to an exemplary embodiment of the present invention;

FIG. 3 is a sectional view of an optical member according to an exemplary embodiment of the present invention;

FIG. 4 is a sectional view of an optical member according to an exemplary embodiment of the present invention;

FIG. 5 is a partial perspective view of an optical member according to an exemplary embodiment of the present invention;

FIG. 6 is a sectional view of an optical member according to an exemplary embodiment of the present invention;

FIG. 7A is a perspective view schematically showing a backlight assembly according to an exemplary embodiment of the present invention;

FIG. 7B is a partial enlarged view of a backlight assembly according to an exemplary embodiment of the present invention;

FIG. 7C is a perspective view schematically showing a backlight assembly according to an exemplary embodiment of the present invention;

FIG. 8A is a perspective view schematically showing a backlight assembly according to an exemplary embodiment of the present invention;

FIG. 8B is a perspective view schematically showing a backlight assembly according to an exemplary embodiment of the present invention; and

FIG. 9 is a perspective view schematically showing a liquid crystal display according to an exemplary embodiment of the present invention.

### DETAILED DESCRIPTION OF EXEMPLARY EMBODIMENTS

The present invention will now be described more filly with reference to the accompanying drawings, in which exemplary embodiments of the invention are shown. The invention may, however, be embodied in many different forms and should not be construed as being limited to the embodiments set forth herein.

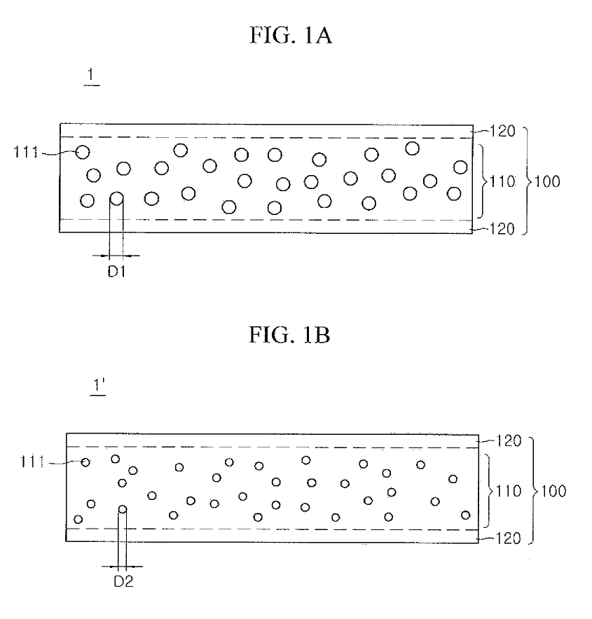

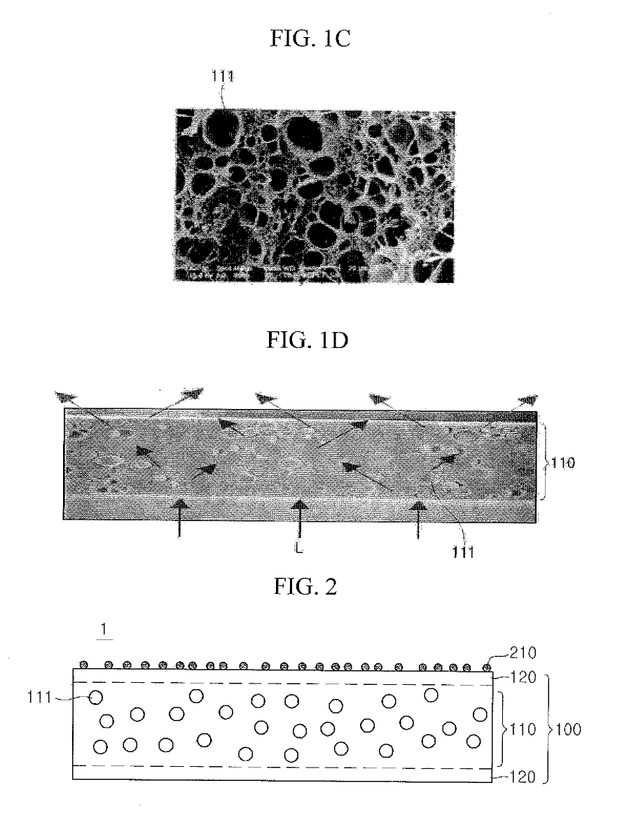

FIG. 1A is a sectional view of an optical member according to an exemplary embodiment of the present invention. FIG. 1B is a sectional view of an optical member according to an exemplary embodiment of the present invention. FIG. 1C is a scanning electron microscope (SEM) photograph of an optical member according to an exemplary embodiment of the present invention. FIG. 1D is a photograph schematically showing a path of light passing through an optical member according to an exemplary embodiment of the present invention.

Referring to FIGS. 1A and 1B, each of the optical members 1 and 1′ includes a base material layer 100 and a foaming portion 110 formed in the base material layer 100. The base material layer 100 may substantially be the optical member 1 or 1′.

The base material layer 100 may comprise a light transmissive resin, for example, a thermoplastic resin. An additive for maintaining the mechanical strength and optical stability of the optical member 1 or 1′ may be included in the base material layer 100. For example, the additive may include at least one of an ultraviolet absorbent, an infrared absorbent, an antioxidant, a heat stabilizer, a selective wavelength absorbent, a flame retardant, a plasticizer, a stabilizer, a lubricant, a coloring agent, a fluorescent bleaching agent or an antistatic agent. The light-transmissive thermoplastic resin of the base material layer 100 may be at least one of an acryl-based resin, a styrene-based resin, a methyl methacrylate-styrene copolymer resin, a polycarbonate-based resin or an olefin-based resin. In an exemplary embodiment, the light-transmissive thermoplastic resin may include at least one of polycarbonate (PC), polystyrene resin (PS), polyethylene terephthalate (PET), polyarylate (PAR), polysulfone resin (PSU), polyethersulfone resin (PES), polypropylene (PP), polyamide (PA), polyphenylene sulfide (PPS), polyimide resin (PI), poly ether-ether-ketone (PEEK), polyurethane resin (PUR), polyvinyl chloride (PVC), methylpentane polymer (PMP), polymethylmethacrylate (PMMA), silicon resin (SI), acryl-based resin or a fluorine resin. In an exemplary embodiment, polyethylene terephthalate or polypropylene is used as the base material layer 100. The optical member 1 or 1′ may be a single-layered plate containing the light transmissive thermoplastic resin or a multi-layered plate.

The base material layer 100 includes the foaming portion 110 and non-foaming portions 120.

The foaming portion 110 is a region where a plurality of foam elements 111 are formed and can be positioned in the middle of the foaming portion 110. A foam element 111 comprises vapor gas located in the path of light L incident on the base material layer 100. The non-foaming portions 120 are provided in the outside regions of the base material layer 100, where the foam elements 111 are not formed. Each of the non-foaming portions 120 is a boundary between the base material layer 100 and any element contacting the base material, and defines a surface of the base material layer 100 and a portion under the surface. Since the foam elements 111 are not formed in the non-foaming portions 120, the surfaces of the base material layer 100 can be smooth and uniform. Thus, the base material layer 100 includes the foaming portion 110 and the non-foaming portions 120 on the upper and lower surfaces of the foaming portion 110.

The foam elements 111 are formed in an intermediate region of the base material layer 100 to form a predetermined foaming portion 110 and arranged randomly in the foaming portion 110. The sizes and shapes of the respective foam elements 111 may not be uniform. The foam 111 has a refractive index different from the base material layer 100, and diffuses light passing through the base material layer 100. That is, light passing through a repeated path of the base material layer 100, the foam elements 111 and the base material layer 100 is refracted and diffused at the respective boundaries between the media. In exemplary embodiments of the present invention, the size of the foam elements 111 for diffusing light can be, for example, approximately 10 μm to approximately 100 μm. If the size of the foam elements 111 exceeds 100 μm, the foam elements 111 occupy a large portion of the thin base material layer 100, and therefore, light passing through the base material layer 100 is not sufficiently refracted and light scattering power is lowered. If the size of the foam elements 111 is 10 μm or less, the refractive index of the foam elements 111 is substantially increased, and therefore, causes light to be reflected.

Referring to FIG. 1A, the size D1 of the foam is approximately 10 μm to approximately 100 μm, and the average size D2 of the foam 111 in FIG. 1B is approximately 10 μm or less. That is, if the foaming portion 110 has the foam elements 111 as shown in FIG. 1A, light passing through the base material layer 100 is refracted several times and diffused. Referring to FIGS. 1C and 1D, the foam elements 111, having about 20 μm on the average, function as a boundary surface between a first medium, i.e., the base material layer 100 comprising a solid resin and a second medium, i.e., the foam elements 111 comprising a vapor gas on the path of light L incident on the base material layer 100, so that refraction of light is generated at the boundary. In the foam elements 111 shown in FIG. 1B, excessive refraction of light can occur. That is, reflection is generated at the boundary. Thus, the optical member 1 in an embodiment described with reference to FIG. 1A functions as a light diffusion member, and the optical member 1′ in an embodiment described with reference to FIG. 1B functions as a light reflection member. That is, the effect of a diffusion or reflection sheet can be achieved by controlling the size of the foam elements 111, so that a production line of the optical member 1 or 1′ can be simplified.

The base material layer 100 may comprise different light-transmissive resins. For example, a resin with a high heat-resistance temperature may be used to form the foaming portion 110, and a resin with a low heat-resistance temperature and good film formability may be used to form the non-foaming portion 120. In an exemplary embodiment, a high-absorbent resin may be used to form the non-foaming portion 120, and a low-absorbent or high-intensity resin may be used to form the foaming portion 110. That is, a combination of various resins may be used to form the foaming and non-foaming portions 110 and 120.

The base material layer 100 may include a light diffusing agent including at least one of silicone-based crosslinked particles, acryl-based crosslinked particles, styrene-based crosslinked particles, methyl methacrylate-styrene copolymer(MS)-based crosslinked particles, calcium carbonate, barium sulfate, aluminum hydroxide, titanium oxide, talcum or glass beads to diffuse light passing through the light diffusing agent. In an exemplary embodiment, the light diffusing agent 123 for providing high transmission and high diffusion includes at least one of silicone-based crosslinked particles, acryl-based crosslinked particles, styrene-based crosslinked particles, methyl methacrylate-styrene copolymer(MS)-based crosslinked particles, calcium carbonate or talcum.

The optical member 1 or 1′ shown in FIG. 1A or FIG. 1B may be manufactured by performing a foaming process using a polyethylene terephthalate or polypropylene resin. As an example of the foaming process, gas such as carbon dioxide is injected into a container having a resin contained therein, and pressure is applied thereto. The resin is pulled out of the container, and then heat is applied to the resin up to a glass transition temperature or more, whereby the gas is captured inside the resin to produce foam. Through such a foaming process, a conventional stretching process can be omitted.

That is, in the conventional stretching process, an amorphous resin is stretched and heated to induce crystallization, and light incident on the crystal lattice of the crystallized resin is refracted therein. However, in an exemplary embodiment, the crystallization of resin rarely occurs, the resin remains as an amorphous resin, and incident light can be diffused by the foam elements 111.

FIG. 2 is a sectional view of an optical member according to an exemplary embodiment of the present invention.

Referring to FIG. 2, an optical member 1 includes a base material layer 100 and a foaming portion 110 formed in the base material layer 100. A plurality of beads 210 are formed on any one surface of the base material layer 100, for example, on at least any one non-foaming portion 120. For example, the beads 210 together with an ultraviolet curing resin are applied to the non-foaming portion 120 and then fixed on the non-foaming portion 120 while being included on the resin cured through an ultraviolet curing process.

The beads 210 are used to diffuse light exiting from the base material layer 100. A large number of beads may be randomly distributed on the surface of the base material layer 100. The bead 210 is formed in the shape of a sphere with a size of about 10 μm to about 20 μm on the average, and comprises an inorganic compound such as Al₂O₃, TiO₂ or SiO₂, an organic compound such as polymethylmethacrylate (PMMA) or polycarbonate (PC), or a mixture of the inorganic and organic compounds. However, the composition of the bead 210 is not limited thereto. That is, various materials for diffusing light may be applied. Through such a configuration of the beads 210, light scattering power can be improved.

The following Table 1 shows data obtained by evaluating luminous uniformity out of TCO (The Swedish Confederation of Professional Employees) '03 certification items for a display to which a conventional example is applied and a display to which an exemplary embodiment is applied. In the conventional example, beads are formed on a base material comprising polyethylene terephthalate without foam elements. In this exemplary embodiment, beads are formed on a base material comprising polyethylene terephthalate with foam elements. For TCO '03 certification, the beads should have a luminous uniformity of 1.7 or less.

TABLE 1

| | Conventional Example | Third Embodiment |
|---|---|---|
| Light Emitting Uniformity | 1.69 | 1.55 |

As shown in Table 1, the luminous uniformity of an exemplary embodiment is 1.55, which is superior to the uniformity of the conventional example of 1.69. That is, light diffusion is induced only by the configuration of beads in the conventional example, whereas, in this exemplary embodiment, light diffusion is induced by the configuration of the foaming portion 110 and the beads 210. Accordingly, light scattering power is enhanced, thereby accomplishing more-improved luminous uniformity.

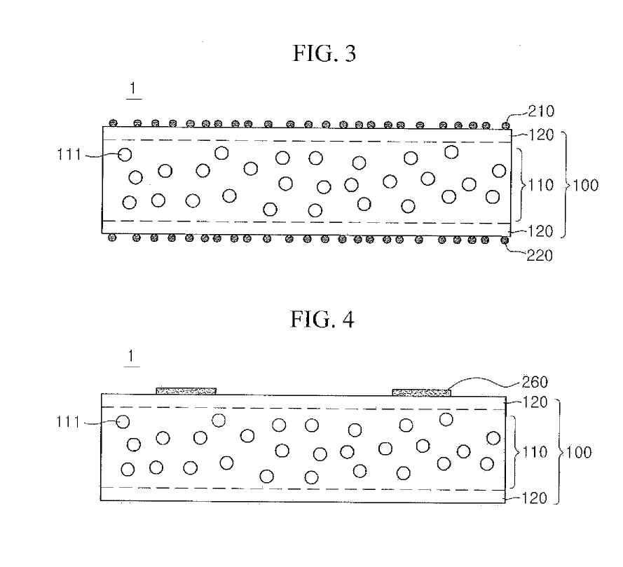

FIG. 3 is a sectional view showing a sectional view of an optical member according to an exemplary embodiment of the present invention.

Referring to FIG. 3, an optical member 1 includes a base material layer 100 and a foaming portion 110 formed in the base material layer 100. A plurality of first beads 210 are formed on one surface of the base material layer 100, and a plurality of second beads 220 are formed on the other surface of the base material layer 100. In an exemplary embodiment, among the beads 210 and 220 formed on the surfaces of the base material layer 100, the number of first beads 210 formed on the one surface of the base material layer 100 may be greater than that of second beads 220 formed on the other surface of the base material layer 100. The second beads 220 may have a smaller size than the first beads 210.

When the optical member 1 is used as a diffusion sheet to a backlight unit of a liquid crystal display (LCD) and supported by, for example, supporters (not shown), the second beads 220 may be provided to prevent the base material layer 100 from being damaged due to the contact with the supporters.

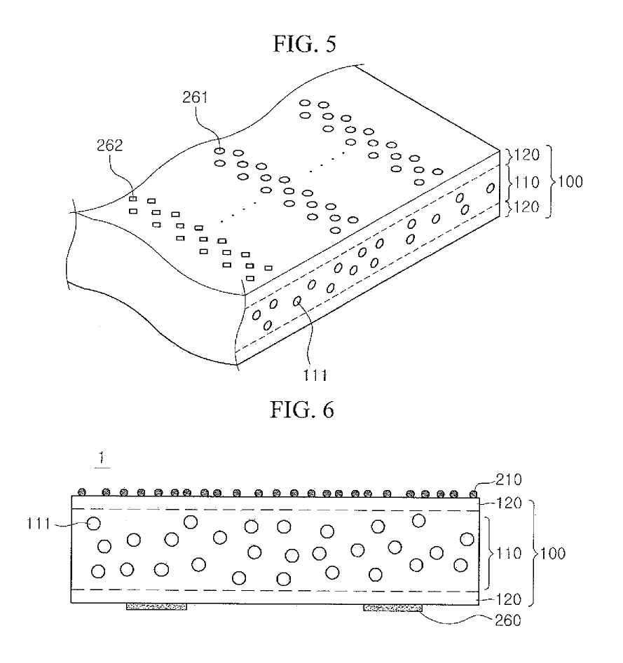

FIG. 4 is a sectional view of an optical member according to an exemplary embodiment of the present invention. FIG. 5 is a partial perspective view of FIG. 4.

Referring to FIGS. 4 and 5, an optical member 1 includes a base material layer 100 and a foaming portion 110 formed in the base material layer 100. A plurality of shielding pattern portions 260 are formed on any one surface of the base material layer 100, for example, on at least any non-foaming portion 120.

The shielding pattern portions 260 can be formed by applying a liquid such as a white ink to the base material layer 100 by, for example, a silk screening method, or a lens pattern rolling method. The shielding pattern portions 260 are provided to prevent the formation of bright lines appearing when linear light sources approach the optical member 1 in a direct-type backlight unit structure. That is, the shielding pattern portions 260 absorb and diffuse light, thereby preventing the bright lines such that the linear light sources is viewed through the optical member 1 without the bright lines.

Conventionally, when such shielding patterns are formed by applying beads to a surface of a sheet, adhesive strength of the shielding patterns is not good. This may cause exfoliation. However, when the shielding pattern portions 260 are applied to the base material layer 100 containing the foaming portion 110, adhesive strength of the shielding pattern portions 260 is enhanced while securing light scattering power of the base material layer 100, thereby preventing the exfoliation of the shielding pattern portions 260.

Referring to FIG. 5, the shielding pattern portions 260 may be formed in a line shape by grouping a series of individual shielding patterns 261 or 262. In an exemplary embodiment, each of the individual shielding patterns may be formed as a circular shaped shielding pattern 261 or a diamond shaped shielding pattern 262, and may have a size of about 0.1 mm to about 10 mm. If the size of the shielding pattern 261 or 262 is below 0.1 mm, it is insufficient to prevent occurrence of bright lines. If the size of the shielding pattern 261 or 262 is over 10 mm, the shielding pattern 261 or 262 may appear on the display screen. The shielding pattern portion 260 formed by grouping the shielding patterns 261 or 262 is formed in a line shape corresponding to a length direction of linear light sources (not shown), so that occurrence of bright lines due to the line light sources can be lowered.

FIG. 6 is a sectional view of an optical member according to an exemplary embodiment of the present invention.

Referring to FIG. 6, an optical member 1 includes a base material layer 100 and a foaming portion 110 formed in the base material layer 100. A plurality of beads 210 are formed on one surface of the base material layer 100, and a plurality of shielding pattern portions 260 are formed on the other surface of the base material layer 100.

In an exemplary embodiment of the present invention, the beads 210 of an embodiment described with reference to FIG. 2 and the shielding pattern portions 260 of an embodiment described with reference to FIG. 4 are applied to the one and the other surfaces of the base material layer 100, respectively. In this exemplary embodiment bright lines occurring when line light sources are disposed close to an optical member can be prevented, and light scattering power can be improved.

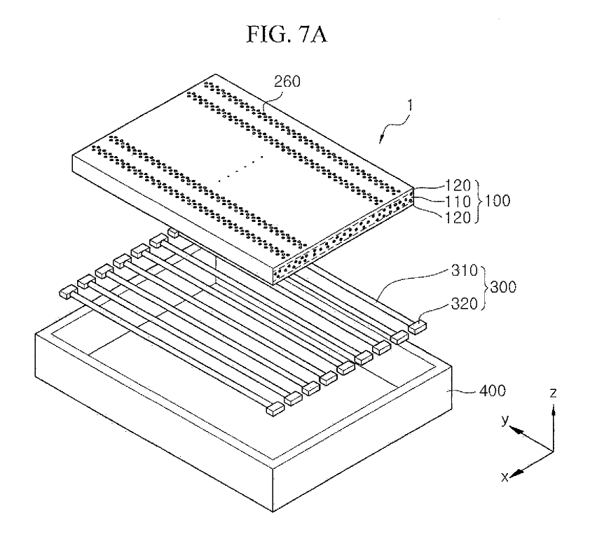

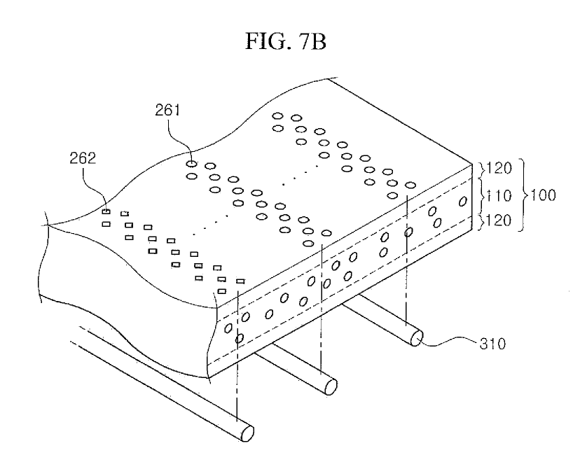

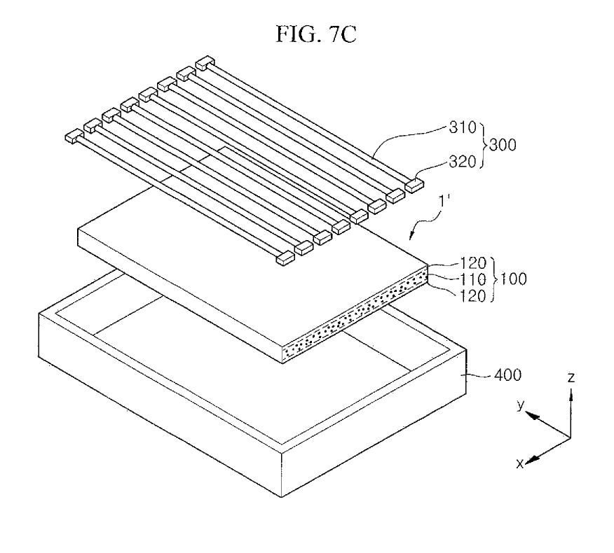

FIG. 7A is a perspective view schematically showing a backlight assembly according to an exemplary embodiment of the present invention. FIG. 7B is a partial enlarged view of lamps and a base material layer in FIG. 7A.

Referring to FIGS. 7A and 7B, the backlight assembly includes a light source unit 300, an optical member 1 provided over the light source unit 300, a receiving member 400 for accommodating the light source unit 300 and the optical member 1.

The light source unit 300 includes a plurality of lamps 310 and lamp holders 320 provided at both ends of the respective lamps 310 for fixedly supporting the lamps 310. For example, cold cathode fluorescent lamps (CCFLs) are used as the plurality of lamps 310. In an exemplary embodiment, all types of lamps for emitting light having a wavelength band of infrared and visible light (i.e., white light) may be used as the plurality of lamps 310. The CCFL includes a glass tube where a mixed gas of Hg, Ne and Ar is provided, positive and negative electrodes provided at both ends of the glass tube, and a phosphor film applied to an inner surface of the glass tube.

The CCFL emits light having a predetermined wavelength band by allowing electrons radiated through an electric field applied between the positive and negative electrodes to cause a state transition of Hg, and the phosphor converts the light in the wavelength band into visible light. In an exemplary embodiment, the visible light is emitted in the z-direction.

The optical member 1 includes the base material layer 100 and the foaming portion 110 formed in the base material layer 100. The optical member 1 serves as a diffusion sheet for uniformly diffusing visible light (i.e., white light) emitted from the light source unit 300 through the foaming portion 110.

In an exemplary embodiment, the shielding pattern portions 260 are formed in a line shape of a series of the shielding patterns 261 or 262 corresponding to the line shape of the lamps 310, thereby absorbing and diffusing light emitted from the lamps 310. With the configuration of the shielding pattern portions 260, the lamps 310 may be disposed close to the optical member 1. The disposition of the lamps 310 close to the optical member 1 forms a thin backlight unit and a thin LCD having the thin backlight unit. The disposition of the lamps 310 close to the optical member 1 reduces the number of the lamps 310 while maintaining the same luminance. In the optical member 1 having the shielding pattern portions 260, bright lines do not occur for the line light sources, and light diffusion is effectively performed, thereby achieving uniform luminance throughout the overall display screen and enhancing light efficiency.

FIG. 7C is a perspective view schematically showing a backlight assembly according to an exemplary embodiment of the present invention.

Referring to FIG. 7C, the backlight assembly includes a light source unit 300 and a receiving member 400 for accommodating the light source unit 300. An optical member 1′ is disposed between the light source unit 300 and the receiving member 400.

The optical member 1′ includes the base material layer 100 and the foaming portion 110 formed in the base material. The optical member 1′ functions as a reflection sheet for reflecting visible light (i.e., white light) emitted from the light source unit 300 through the foaming portion 110.

In an exemplary embodiment, the backlight assembly may include both of the optical member 1 where a diffusion function is added and the optical member 1′ where a reflection function is added. That is, the optical member 1 is disposed over the light source unit, and the optical member 1′ is disposed between the light source unit 300 and the receiving member 400.

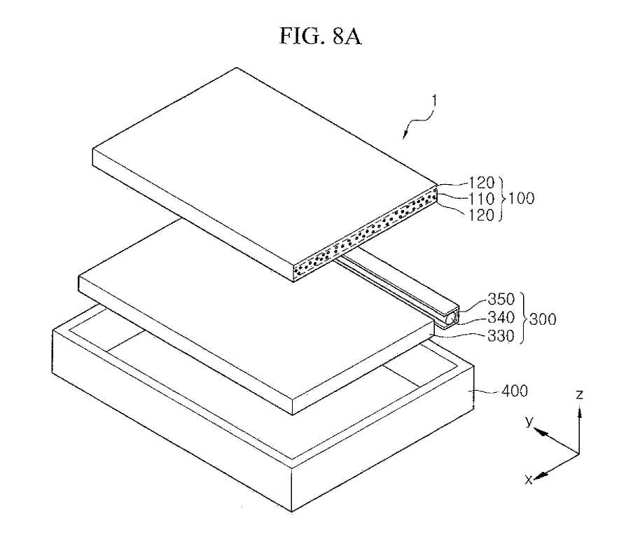

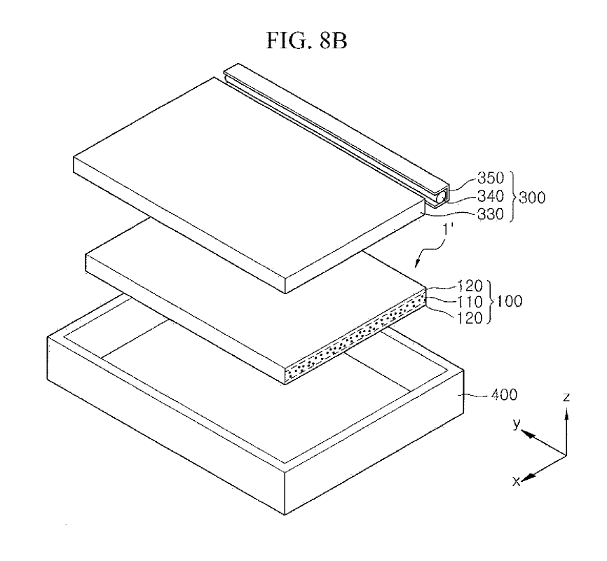

FIGS. 8A and 8B are perspective views schematically showing backlight assemblies according to exemplary embodiments of the present invention.

Referring to FIGS. 8A and 8B, each of the backlight assemblies may include a light guide plate 330, a lamp 340 provided at one side of the light guide plate 330, and a cover unit 350 for inducing light emitted from the lamp 340 to the light guide plate 330. The light guide plate 330 converts light having an optical distribution of a linear light source, which is emitted from the lamp 340, into light having an optical distribution of a surface light source.

In an exemplary embodiment of the present invention, an optical member 1 with a diffusion function added thereto is disposed over the light source unit 300. In an exemplary embodiment of the present invention, an optical member 1′ with a reflection function added thereto is disposed between the light source unit 300 and a receiving member 400. The backlight assembly may have a configuration in which the optical member 1 is disposed over the light source unit, and the optical member 1′ is disposed between the light source unit 300 and the receiving member 400.

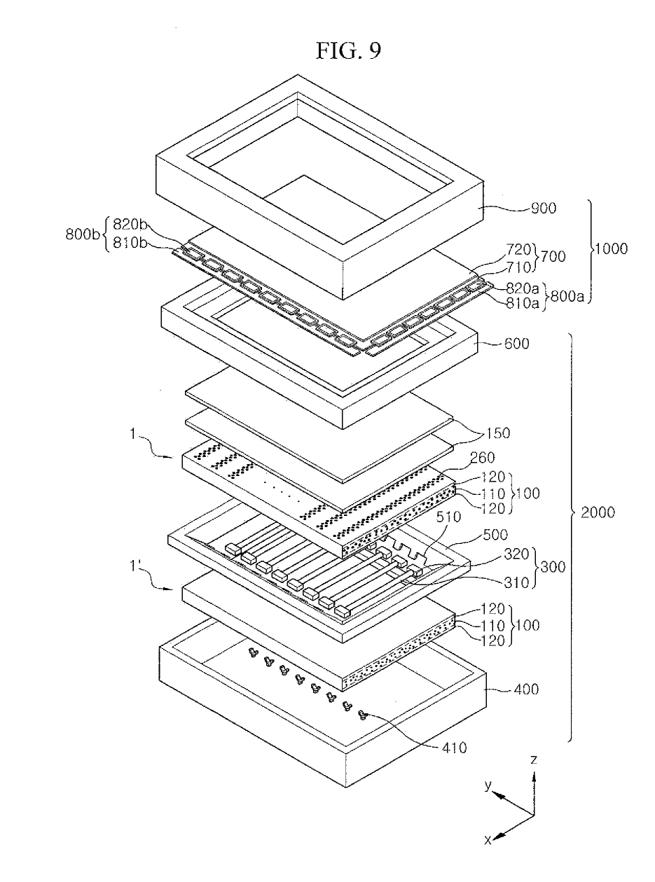

FIG. 9 is a perspective view schematically showing a liquid crystal display (LCD) according to an exemplary embodiment of the present invention.

Referring to FIG. 9, the LCD includes a display assembly 1000 and a backlight assembly 2000 disposed behind the display assembly 1000.

The display assembly 1000 includes an LCD panel 700, driving circuit units 800a and 800b, a lower receiving member 400, and an upper receiving member 900.

The LCD panel 700 includes a color filter substrate 720 and a thin film transistor (TFT) substrate 710. The driving circuit units 800a and 800b includes a gate-side printed circuit board (PCB) 810a connected to gate lines of the TFT substrate 710 through gate-side flexible PCBs 820a, and a data-side PCB 810b connected to data lines of the TFT substrate 710 through data-side flexible PCBs 820b. In an exemplary embodiment, the gate-side PCB 810a may be omitted.

The upper receiving member 900 is formed in the shape of a rectangular frame with planar and sidewall portions perpendicularly bent therefrom to prevent components of the display assembly 1000 from escaping from the LCD and to protect the LCD panel 700 or the backlight assembly 2000 against external impact. The planar portion of the upper receiving member 900 supports a portion of an edge of the LCD panel 700 at a lower portion of the planar portion, and the sidewall portions are coupled to sidewalls of the lower receiving member 400. For example, the upper and lower receiving members 900 and 400 are manufactured using a metal with good strength, light weight and low deformation.

The backlight assembly 2000 includes a light source unit 300 for generating light, a fixing member 500 for fixedly supporting the light source unit 300, optical members 1 and 1′ disposed over and under the fixing member 500, optical sheets 150 disposed over the optical member 1, a supporting member 600 for supporting the optical member 1 and the optical sheets 150, and the lower receiving member 400 for accommodating the light source unit 300, the fixing member 500, the optical members 1 and 1′ and the optical sheets 150.

The light source unit 300 includes a plurality of lamps 310 disposed at the same intervals and lamp holders 320 provided at both ends of the respective lamps 310. In an exemplary embodiment of the present invention, the lamps 310 are disposed so that the longitudinal direction of the lamp 310, i.e., the x-direction, is perpendicular to the longitudinal direction of the lower receiving member 400, i.e., the y-direction. The arrangement of the lamps 310 is not limited thereto. For example, the lamps 310 may be disposed so that the longitudinal direction of the lamp 310 is parallel with the longitudinal direction of the lower receiving member 400, i.e., the y-direction.

The fixing member 500 has a shape of a frame with a bottom opened, and a plurality of concave portions 510 for fixedly supporting the lamp holders of the light source unit 300 at one side of the fixing member 500. Accordingly, the fixing member 500 fixedly supports the plurality of lamps 310 of the light source unit 300, thereby preventing the lamps 310 from shaking and protecting the lamps 310 against external impact. The fixing member 500 may be modified in various shapes to fixedly support the plurality of lamps 310 of the light source unit 300.

The optical member 1 provided over one side of the fixing member 500 includes the base material layer 100 where the foaming portion 110 is formed. For example, the optical member 1 has the shielding pattern portions 260. The optical member 1 may be a diffusion plate.

The base material layer 100 of the optical member 1 allows light incident from the light source unit 300 to be directed to the LCD panel 700, and diffuses the light to have uniform distribution in a broad range, thereby illuminating the LCD panel 700. In an exemplary embodiment, the light is emitted in the z-direction.

The optical member 1′ provided under the other side of the fixing member 500 includes the base material layer 100 where the foaming portion 110 is formed.

The optical member 1′ includes the base material layer 100 and the foaming portion 110 formed in the base material layer 100. The optical member 1′ functions as a reflection sheet for reflecting visible light (i.e., white light) emitted from the light source unit 300 by the foaming portion 110, so that light proceeding in (−)z-direction is reflected in the z-direction.

The optical sheets 150 may include at least one polarizing sheet, at least one luminance enhancement sheet and at least one diffusion sheet. The polarizing sheet converts light slantingly incident on the polarizing sheet into vertical light. The luminance enhancement sheet transmits light parallel with a transmission axis of the luminance enhancement sheet and reflects light perpendicular to the transmission axis. The diffusion sheet allows incident light to be diffused and emitted to have an optical distribution of a surface light source. The diffusion sheet may have a configuration of the optical member 1 according to an exemplary embodiment of the present invention. Accordingly, light is incident in a direction perpendicular to the LCD panel 700, thereby enhancing the light efficiency. The optical sheets 150 may be provided over the optical member 1 or may be attached onto the optical member 1 in a light emission direction, i.e., the z-direction. In an exemplary embodiment the thickness of the backlight assembly 2000 and the LCD can be reduced.

The optical member 1 may further include a coating layer having a function such as infrared absorption. The optical sheets 150 may be attached onto the optical member 1.

The supporting member 600 may have a rectangular frame shape, and supports the optical member 1 and the optical sheets 150. The supporting member 600 supports the LCD panel provided at a top portion thereof.

The lower receiving member 400 is formed in the shape of a rectangular hexahedron, so that a receiving space with a predetermined depth is defined inside of the lower receiving member 400. A plurality of lamp fixing members 410 are provided in the lower receiving member 400 to support the lamps 310 of the light source unit 300, thereby preventing sag of the lamps 310 and damage thereof caused by external impact. A plurality of the fixing members 410 may support each lamp 310. A reflective plate may be provided on the bottom surface of the lower receiving member 400.

According to exemplary embodiments of the present invention, an optical member comprises a foaming resin. The optical member has no light diffusing agent in a base material layer, and does not require a conventional stretching process. As such, light scattering power can be secured.

In exemplary embodiments, the effect of a reflection or diffusion sheet can be achieved by controlling the size of foam elements in the optical sheet whereby production lines can be simplified.

In exemplary embodiments, beads are applied to one surface of the foaming resin, thereby enhancing light scattering power and achieving improved luminous uniformity. Beads are applied on the other surface of the foaming resin, whereby the optical member can be supported by supporters without damage while enhancing light scattering power.

In exemplary embodiments, the number of light sources can be reduced by enhancing light scattering power, and a distance between the light source and the optical member can also be reduced.

In an exemplary embodiment, light uniformity can be enhanced without occurrence of bright lines, and intensity of light to be viewed is secured, thereby enhancing luminance.

For example, effective light diffusion is performed for light having an optical distribution of a linear light source, thereby achieving uniform luminance throughout an overall display screen and enhancing efficiency of emitted light.

Although exemplary embodiments of the present invention have been described herein with reference to the accompanying drawings, it is to be understood that the present invention should not be limited thereto and that various other changes and modifications may be affected therein by one of ordinary skill in the related art without departing from the scope or spirit of the invention. All such changes and modifications are intended to be included within the scope of the invention.

What is claimed is:

1. An optical member, comprising:
a base material layer; and
a foaming portion formed in the base material layer, the foaming portion having a plurality of foam elements.

2. The optical member as claimed in claim 1, wherein the base material layer includes polyethylene terephthalate (PET) or polypropylene (PP).

3. The optical member as claimed in claim 1, wherein the foam elements have an average size of about 10 μm to about 100 μm or an average size of 10 μm or less.

4. The optical member as claimed in claim 1, further comprising a plurality of beads arranged on at least one surface of the base material layer.

5. The optical member as claimed in claim 4, wherein the beads have an average size of about 10 μm to about 20 μm.

6. The optical member as claimed in claim 4, wherein the plurality of beads include two or more types of beads with different indices of refraction.

7. The optical member as claimed in claim 4, wherein the plurality of beads are formed on more than one surface of the base material layer, and a number of beads formed on a first surface of the base material layer is larger than that of the beads formed on a second surface thereof.

8. The optical member as claimed in claim 1, wherein a plurality of beads are formed on a first surface of the base material layer, and a shielding pattern is formed on a second surface thereof.

9. An optical member, comprising:
a base material layer; and
at least one shielding pattern formed on at least one surface of the base material layer.

10. The optical member as claimed in claim 9, wherein the at least one shielding pattern is arranged in a line shape.

11. The optical member as claimed in claim 9, wherein the at least on shielding pattern comprises a diamond shaped shielding pattern or a circular shaped shielding pattern.

12. The optical member as claimed in claim 9, wherein the at least one shielding pattern is found corresponding to a position of a lamp disposed under the base material layer.

13. The optical member as claimed in claim 9, wherein the at least one shielding pattern has a width of about 0.1 mm to about 10 mm.

14. A display, comprising:
a backlight assembly having a light source unit and an optical member containing a foaming portion formed in a base material layer, the light source unit emitting light to be incident on the optical member, the foaming portion having a plurality of foam elements; and
a display panel disposed at a light exiting side of the backlight assembly to display an image.

15. The display as claimed in claim 14, wherein the foam elements have an average size of about 10 μm to about 100 μm or an average size of 10 μm or less.

16. The display as claimed in claim 14, wherein a shielding pattern is formed on at least one surface of the base material layer in correspondence to the light source unit.

17. The display as claimed in claim 14, wherein the optical member is at least one of a diffusion sheet, a reflection sheet or a diffusion plate.
